(19) United States
(12) Patent Application Publication
(10) Pub. No.: US 2026/0335713 A1
(43) Pub. Date: Oct. 29, 2026

(54) CRICKET BALL TRACKING AND PREDICTION SYSTEM

(71) Applicant: ARC SIMULATIONS LTD, London (GB)

(72) Inventors: Michael ARMENAKIS, London (GB); Henry SMITH, London (GB)

(21) Appl. No.: 19/158,940

(22) PCT Filed: Feb. 23, 2024
(86) PCT No.: PCT/GB2024/050506

§ 371 Date: Aug. 22, 2025

(30) Foreign Application Priority Data
Feb. 24, 2023 (GB) 2302759.2

(51) Int. Cl. A63B 24/00; A63B 37/04; A63B 43/00; A63B 69/00; A63B 71/06

(52) U.S. Cl. CPC A63B 24/0021; A63B 37/04; A63B 43/00; A63B 69/0015; A63B 71/0622; A63B 2024/0034; A63B 2209/00; A63B 2220/31; A63B 2220/89

(57) ABSTRACT

The present invention provides a cricket ball tracking and path prediction system comprising: a cricket ball (18) with a UWB tag (22) contained therein. At least four UWB anchors (24) communicate with the UWB tag and are placed around a constrained playing area (12). A processor (28) is arranged to receive positional and accelerometer data from the UWB tag, and uses it to determine delivery and shot parameters. These include: when a delivery of the cricket ball has been initiated; if/when the cricket ball has been struck by a batter; a delivery path; a shot path within the constrained playing area; vector velocities of the cricket ball upon strike; and predict the shot path outside the constraints of the constrained playing area. The invention also provides a method of doing this and a ball that may be used in this and other ball tracking scenarios.

The present invention relates to a cricket ball tracking and path prediction system and to a method for tracking and predicting ball position. The invention also provides a cricket ball including a tracker that may be suitable for use in such a system and method or in different tracking systems.

The tracking of sports balls and indeed cricket balls for analytical purposes is known. Such methods tend to involve the tracking of a ball during normal game play using sensors and the subsequent download and analysis of the data derived therefrom. Such data can be useful to reveal particular playing trends, which can thereafter be worked analysed and or used to adapt game play. Prior art methods relating to cricket such as that embodied in U.S. Pat. No. 10,420,999 tend to focus on the tracking of a cricket ball to analyse spin metrics and are aimed at improving bowling performance. Such methods typically track a cricket ball during normal play conditions, rather than specifically in a training environment. The sensors typically employed in known methods include accelerometers, gyroscopes, magnetometers etc. Also they have used a very limited number of external positional sensors so as not to impinge on play with the consequence of poor accuracy. Placement of sensors to track sports balls, without impeding the ball characteristics and affecting the normal flight path can be difficult. Factors such as weight and size of cricket balls are regulated and even weight distribution is important. In addition the need for power to be provided to any ball mounted sensor can render their utility limited by battery life. Thus manufacturing a ball to a sufficient standard to not adversely effect the user experience, whilst having real time tracking and sufficient power to operate long enough has not before been done as it is prohibitively expensive using prior art methods.

The present invention aims to provide an improved system for tracking and predicting the flight of a cricket ball, and a method for tracking and predicting the flight of a cricket ball in such a system or otherwise. These serve to address at least some of the issues discussed above. The invention uses ultra wideband (UWB) technology preferably coupled with accelerometer data.

A further aim is to provide an improved cricket ball that can be tracked, and which has substantially unimpaired use characteristics for players and a rechargeable power supply. This ball can be part of the system or used in a different system.

According to a first aspect of this invention, there is provided a cricket ball tracking and path prediction system, the system comprising: a cricket ball having a UWB tag contained therein; at least four UWB anchors that communicate with the UWB tag and are configured for placement around a constrained playing area; a processor arranged to receive calculated positional data from the UWB anchors and UWB tag, the processor being configured, using the calculated positional data, to:
determine when a delivery of the cricket ball has been initiated;
determine if and when the cricket ball has been struck by a batter;
define a delivery path and a shot path within the constrained playing area;
determine the vector velocities of the cricket ball upon strike; and
predict the shot path outside the constraints of the constrained playing area.

According to a second but closely related aspect of this invention, there is provided a cricket ball tracking and path prediction method comprising;
gathering positional data for the cricket ball using a UWB tag within the cricket ball and at least four UWB anchors placed around a constrained playing area, the UWB anchors being in communication with the UWB tag;
determining when a delivery of the cricket ball has been initiated;
determining if and when the cricket ball has been struck by a batter;
defining a delivery path and a shot path within the constrained playing area;
determining the vector velocities of the cricket ball upon strike; and
predicting the shot path outside the constraints of the constrained playing area.

The UWB tag and UWB anchors together form a UWB sensor system which is configured to generate data relating to the position of the cricket ball. The positional data preferably comprises a series of three-dimensional time-stamped locations. The UWB tag will preferably send radio signals to the anchors. The frequency of the radio signal may be within the range of 6-7 GHz.

Preferably the ball also contains an accelerometer associated with or forming part of the UWB tag to provide data about changing forces on the ball.

Determining the locations of the cricket ball may be achieved using a combination of data analysis including one or more of: Time of Arrival (ToA), Angle of Arrival (AoA), Time difference of Arrival (TDoA) and Phase Difference of Arrival (PDoA). Using UWB wireless protocol along with a minimum of four anchors, the locations of the UWB tag, and thus the cricket ball, can be determined with great accuracy. Preferably 6 or more anchors are used. Preferably the locations of the cricket ball can be determined within an accuracy less than 10 cm.

The frequency of the time-stamped locations will depend upon the sampling rate of the data gathered from the UWB sensor system. Preferably, the sampling rate is greater than 100 Hz—i.e. at least 100 positions per second.

The present invention aims to assist with the improvement of batting as well as bowling performance with an emphasis on the analytics of the flight path of a cricket ball following a strike by a batter and the outcome of the shot in a simulated game situation. Thus net training can include enhanced bowling and shot metrics to aid both improvement of a bowler's and a batter's play.

The invention involves the tracking of a cricket ball within a physical world to enable at least part of the path of the cricket ball to be accurately observed and/or recorded and part predicted with a high degree of confidence. Preferably the playing area is constrained by a training net. Cricket training nets comprise netting arranged around a rectangular pitch usually along each side of the pitch and along the rear. Often the area is enclosed with netting extending over the pitch. The net at the bowling end of the pitch is typically left open to facilitate the run-up of a bowler, but it may also be constrained at a suitable point. The use of a net is beneficial inside or outside for bowlers and batters to practice their cricketing techniques whilst providing convenience when retrieving the cricket ball, following a shot. Additionally, the use of nets during training can provide enhanced safety by protecting those in close proximity. Preferably the constrained playing area comprises or contains a single cricket pitch, i.e. the playing strip. The cricket pitch is sometimes referred to as the wicket and is typically 20.12 m (22 yards) and 3.05 m (10 feet) wide.

The processor utilises positional data derived from the UWB sensor system. This may include data provided by the accelerometer. The use of a single UWB tag within the cricket ball minimises changes to the internal structure of the cricket ball, as compared to standard cricket balls. In this way the weight, size and other cricket ball characteristics can be maintained as authentically as possible.

The UWB anchors may be appropriately spaced around the constrained playing area. The UWB anchors are preferably placed in predefined known locations around the constrained playing area. Locations may be predefined or may be ascertained at set up during calibration. The anchors having a known location allows the relative position of the UWB tag to be determined by each anchor and compared/triangulated between the multiple anchors. The anchors should be at locations to give good coverage over the whole tracked area. The ground location and height off the ground can be varied to improve accuracy of a particular set up.

More than one cricket pitch and ball flight can be tracked by a single set/array of anchors and processed by the same processor. For such a multi-net setup the position and number of anchors will vary according to the parameters of the net set up. 12-16 anchors may be suitable for a standard configuration of 6-8 nets. In such a multi ball tracking system the signals from the ball would be individually recognisable such that the positional data for each can be discrete, despite collection by interaction with the same anchors. The system may be configured to display individual tracking data to each net.

The timestamped locations of the ball will preferably define a raw tracked path of the cricket ball. This may then be further used by the processor to derive an enhanced digital model of the delivery path (from bowler release to bat strike) and the shot path (from strike onwards).

The present invention may utilise a digital twin model of the physical world of the playing area. The playing area and/or cricket pitch may be separated into specific location zones and the delivery of the cricket ball may be detected by the cricket ball passing from one zone to another. Preferably two location zones are defined at the delivery end of the digital representation of the playing area and these serve as trigger zones to initiate the processor to calculate and potentially display a digital model upon detection of a delivery. The provision of location zones within the digital representation allows known events and logic to be managed effectively. The digital model will preferably continue to calculate a digital model of ball path using the timestamped locations of the cricket ball until either no change in positional data is received by the processer for a pre-set time, such as three seconds, or the cricket ball has exited the tracked area, e.g. by hitting the constraints of the constrained playing area.

A digital filter may be used to predict and train the digital model to improve location accuracy. An example of suitable filter may be a Kalman filter.

A particular challenge encountered by the inventors in the tracking of a cricket ball is determining if the cricket ball has been struck by a batter.

One way of doing this may include looking at characterising the accelerometer and location data together using machine learning algorithms to determine changes in acceleration. The locations are then used to classify the key stages of a delivery, including the release point of the ball, the bounce of the ball and the contact point of the ball with bat if a shot is played.

The release point can be characterised by a drop in linear acceleration and a change to the freefall acceleration occurring at the popping crease where the ball will be delivered by the bowler or bowling machine. Once the release point is characterised, the bounce point, if a bounce occurs, can be classified as the next change in acceleration occurring within the acceptable location error of the ground. The fusing of this data allows for the machine learning algorithm to accurately determine the timestamp of the bounce and thus create the first set of locations associated to the trajectory of the delivery prior to the bounce.

If a bounce point is determined (i.e. the ball hits the ground) the machine learning algorithm then proceeds to determine the timestamp of the contact point if a shot occurs, this will be when the next change in acceleration occurs. If a contact point is determined the second set of locations represent the path of the ball prior to the bounce and a trajectory can be calculated.

If a contact point is determined the final set of locations are characterised as the shot path. These locations represent those found between the contact point and either the extremity of the net as classified by the predefined net size or by a final change in acceleration when the ball is in contact with the net. When tracking, locations are registered throughout the whole shot until the ball is either picked up by a bowler (who may field in their follow through) or reaches the boundary of a tracked area.

For each of these location sets a line of best fit may be derived using linear regression to further improve the accuracy of the system and determine the true trajectory of the ball through pre-bounce delivery, post-bounce delivery and shot path.

Alternatively without an accelerometer, a first line of best fit may be defined for a set of pre-strike timestamped locations and a second line of best fit is defined for a set of post-strike timestamped locations and an intersect between the two lines (i.e. a non-zero angle between those lines) determines that the cricket ball has been struck. The location of the cricket ball when it has been hit may also be determined this way. The set of pre-strike timestamped locations will preferably comprise locations following delivery of the cricket ball. This may for example comprise the first 20 timestamped locations. The set of post-strike timestamped locations will preferably comprise locations prior to the cricket ball reaching the constraints (e.g. the net) of the constrained playing area. This may comprise the last ten timestamped locations. The lines of best fit may be derived using linear regression.

A further alternative method without an accelerometer may use a change point detection algorithm that looks for changes in trends (i.e. turning points) to highlight potential contact points. These can be discounted using known parameters. For example the contact point should lie between 0 and 6 meters from the stumps.

To detect change in direction representing bounce and contact point of the ball a change point detection algorithm can be used. Change point detection looks to identify changes in trends on a time series data set. In such cases changes in the 3-Dimensions X, Y and Z are considered to identify potential changes and select the most likely change point based on known parameters. A PLANT based model can be used, which is suited for detecting change in slope on a noisy trajectory. This aims to look at the residual error of segments of the trajectory using a multiple linear regression model. There are two key steps including a WINLINFIT to identify a set of candidate change points where there is a change in slope using least-squares fitting and likelihood. The second step MERGING, then applies a hierarchical test on adjacent segments using a confidence level. Once a set of change points has been determined the results are then filtered taking out known change points and constraints. These include, removing the bounce point where there will always be a change point due to the contact of the ball with the playing surface, and removing points that lie outside of the ‘striking zone’ (which may be defined between 0 and 6 m from the stumps at the batter's end). Finally, the change points in each dimension are compared as it is likely when the ball is hit that there will be changes in more than one dimension. If a viable candidate for a contact point is found the ball path is split into delivery and shot path respectively. If no viable points are found then it can be derived that the ball was not hit and the whole ball path will be treated as the delivery path. Often the ball will bounce in the delivery path before it reaches the batter. A bounce point may also defined by the lowest point in trajectory when that coincides with the lower region of the virtual space defined for example in the digital twin. Alternatively a similar method to the one above may by used to determine if a bounce has occurred. In this case however the method will preferably use lines of best fit to define a path along a vertical plane for the cricket ball. In this way, a first line of best fit may be defined for a set of pre-bounce timestamped locations and a second line of best fit is defined for a set of post-bounce timestamped locations and an intersect between the two lines determines that the cricket ball has bounced. The location of the cricket ball when it bounced may thereafter be determined. The set of pre-bounce timestamped locations may comprise locations following delivery of the cricket ball. The set of post bounce timestamped locations may comprise locations prior to the cricket ball being struck by a batter. The lines of best fit may be derived using linear regression.

Once a strike has been determined the tracked path derived from the calculated locations, is divided into a delivery path and a shot path. By separating the delivery and shot paths of the cricket ball it is possible to look at each path individually. Preferably the method and system of the present invention may be used to provide a virtual prediction of the trajectory of the cricket ball for the delivery and/or shot paths.

The predicted trajectory may be a ballistic path as a curved path more accurately reflects the path of cricket ball in the real world.

Preferably, the processor is configured to produce a ballistic trajectory prediction for the delivery path based upon the initial timestamped locations thereof. The processor may do this based on the initial vector velocities of the cricket ball after delivery. Error analysis is preferably carried out to verify the accuracy of the prediction. The error analysis may comprise root mean square error analysis. Following error analysis, the predicted delivery trajectory may be used to enhance and calibrate the accuracy of the tracked trajectory.

The processor may be configured to predict the initial vector velocities of the cricket ball at the start of the strike and produce a ballistic trajectory for the shot path based upon the initial timestamped locations thereof. Preferably the processor includes a physics simulator to predict the shot path beyond the constraints of the constrained playing area. The physics simulator preferably uses the vector velocities of the cricket ball at the start of the strike as the initial parameters for the strike trajectory. The simulator may then generate a virtual path beyond the constraints of the constrained playing area and determine the result of the strike such as the distance and direction of travel, the field bouncing location(s) and the scoring potential. The virtual path may be displayed visually to the users overlaid on a digital representation of the playing area.

Preferable the processor is configured to analyse the predicted shot path to determine game play scenarios. That could include the input or customisation of cricket ground parameters such as boundary location and ground hardness, weather parameters such as wind speed and direction, virtual fielder starting position and movement speeds/skill levels. The shot path may then be analysed relative to these. For example, it could predict if any virtual fielders, running at a defined rate, would be able to intersect the path of the ball within the boundary, and if so which fielder can do this with the shortest distance covered. If a virtual fielder cannot intersect the shot path (and the shot path predicts sufficient distance travelled) then this will result in a boundary which will be a “4” if the ball is predicted to bounce and a “6” if it is not. If there is a possible fielder intersection, the system of the present invention may determine how long it takes to intersect and if the ball has bounced before the point of intersection. If it hasn't bounced it may result in a catch. If it has bounced, then instead the time taken will be compared to how many runs the simulated batter can complete in this time. The simulation can also predict how long before an intercepting fielder could return the ball to the stumps and how fast a batter might run between the wickets to provide a value for runs scored.

All of the data collected by the system from start to finish may be stored for further analysis. On the completion of each delivery, metrics such as the speed of delivery, where the ball pitched (bounced), amount of swing (lateral movement in the air during the delivery path), strike/contact point, shot speed, launch angle of the shot, shot result and run area are all calculated. These are then used to show coaches and players particular playing trends thus allowing them to develop and analyse their technique.

The bowler, initiating delivery of the cricket ball, may be a person, i.e. an individual practicing their bowling technique. Alternatively, the bowler may comprise a cricket ball bowling machine. A bowling machine may be used by a batter wishing to practice their batting technique without the assistance of a person.

A screen may be operatively connected to the processor to provided output data to users. That data may include graphic representations of the playing area as well as ball delivery tracking and shot path prediction overlaid thereon. It may in certain preferred embodiments also provide an indication of the location of virtual fielders and the predicted outcome of a shot. More than one display may be provided, for example this may include one or more the following locations: adjacent the batter (normally protected from ball strike), adjacent the bowler similarly protected; in a coaching station; and in a viewing position for other spectators.

The screen may display a visual digital representation in the form of a two-dimensional or three-dimensional image of the playing area and/or cricket pitch. The positional and contact point data derived from the UWB/accelerometer sensor and processed by the processor is preferably displayed on the digital representation.

The system may include a virtual or augmented reality headset or display. This may be part of an adapted cricket helmet. This may facilitate a visual real time simulation of the shot path of the cricket ball beyond the constraints of the constrained playing area.

An interface may be provided to allow a user to change parameters during use or otherwise control operation.

The processor may comprise a computer running software that undertakes the required calculations and modelling and having a memory to store data as required.

The present invention may be used for training but may also provide an entertainment simulator.

A further aim of the present invention is to provide an improved cricket ball that can be tracked and which has substantially unimpaired use characteristics for players and a rechargeable power supply.

Therefore in a yet further aspect of this invention there is provided a cricket ball comprising: an inner core formed from a non-conductive material; a wireless communication device contained within the inner core and at the centre of the ball and configured to transmit and receive a wireless signal; an inductive charging component to which the communication tag is electrically connected and an outer shell surrounding the inner core and charging loop.

The aerodynamics of the cricket ball are important and should not be compromised by the construction of the ball. To address this, it is important that the cricket ball has an even weight distribution. Preferably, the inner core is spherical.

The inner core is preferably a solid material in which the wireless communication device is embedded, or a multipart casing fixed around the wireless communication device. The core material may be a polymeric material such a resin or ideally a silicone based material. The core may preferably be a silicone based material or a polyurethane resin. Preferably the silicone or resin or other non-conductive material is not permeable to liquid thus protecting the wireless communication device. Preferably the silicone or resin or other non-conductive material should have a low dielectric constant. This ensures that the wireless communication device can be potted completely providing complete protection without attenuating any radio based signals emitted. Preferably the silicone or resin or other non-conductive material has a shore hardness between A-60-100 to ensure that the material matches the properties of the cork surrounding the inner core. This allows for the tuning of the cricket ball properties to match that of a professional standard ball in both weight and feel.

The wireless communication device may preferably be an ultra wideband (UWB) tag configured to transmit and receive a UWB signal. Preferably the UWB has an accelerometer associated therewith to provide force data. Where a UWB tag is provided the ball according to this yet further aspect of this invention and its optional features may be utilised in the method and system defined in the other aspects of the invention.

The wireless communication device may instead, or as well as, include GPS to calculate the position of the ball. This may involve RTK (real-time kinematic) or PPK (post-processed kinematic) GPS technologies. This would facilitate tracking in an unconstrained situation such as a real game on a full ground.

The inductive charging component may use any type of wireless charging technology. It may have a receiver in the form of an inductive charging loop that operates using magnetic induction. The charging loop is located in the centre of the core and is thus charged via a secondary charging coil. When the ball is placed within the magnetic field of the secondary charging coil the magnetic resonance of the two coils are converted to an electrical current using a printed circuit board (PCB) located inside the ball.

The ball may comprise an outer core that surrounds the inner core and is also itself surrounded by the outer shell. The inductive charging loop may be within or on the surface of the inner core, external to the outer core, or located in an outer region of the outer core, but inward of the outer shell.

In order that it be better understood, but by way of example only the present invention will now be described with reference to the accompanying drawings in which:

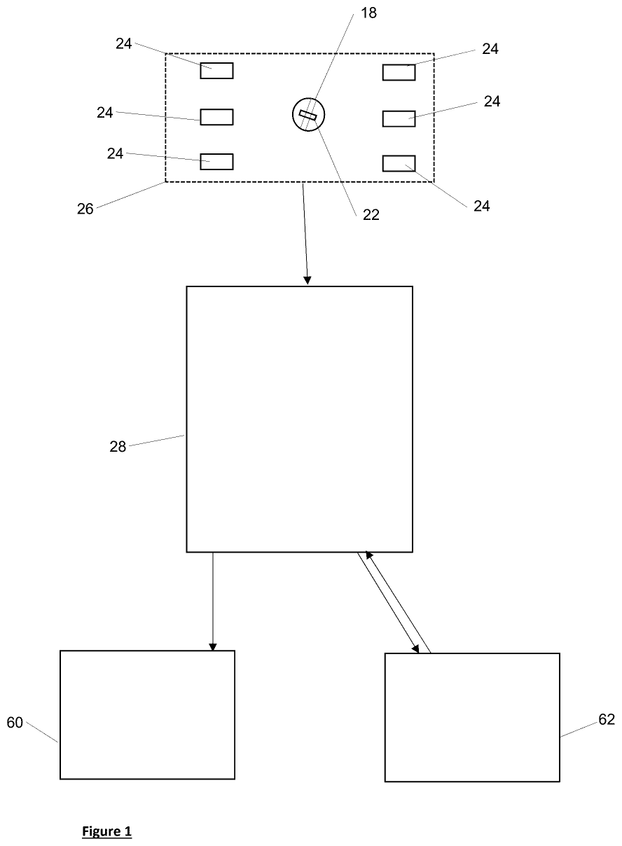

FIG. 1 is a schematic representation of an embodiment of system according to the present invention;

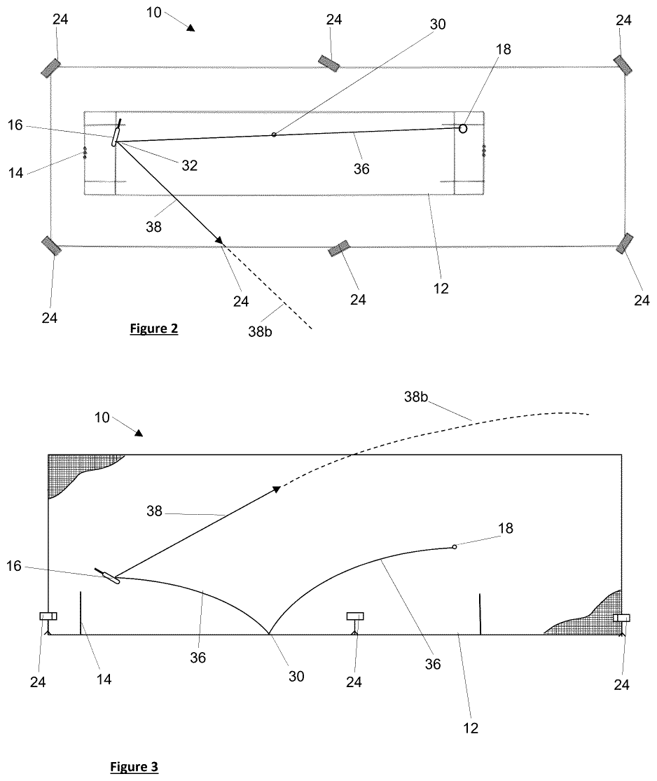

FIG. 2 is a plan view of a cricket pitch surrounded by a net where the system and/or method of the present invention is used to track and predict the flight of a ball before and after it is hit;

FIG. 3 is a side view of the set up in FIG. 2;

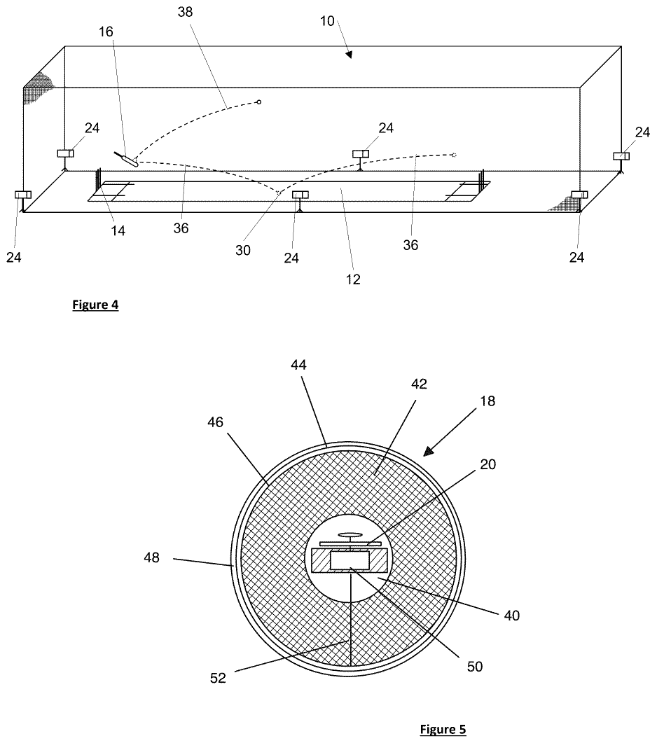

FIG. 4 is a perspective view of a pitch and net set up as shown in FIGS. 2 and 3; and

FIG. 5 is a cross-section through an embodiment of cricket ball according to an aspect of the present invention.

FIG. 1 is a schematic representation of a tracking and prediction system according to the present invention. The system is for tracking a cricket ball when bowled and potentially hit (i.e. in use) by a batter in a constrained playing area such as a cricket net. FIGS. 2 to 4 show a single netted playing area in more detail with the ball path laid out. These figures will be described together.

A playing area generally indicated 10 includes a cricket pitch 12 marked out on a playing surface. That surface may be any suitable type of surface such as natural grass or artificial matting. In these figures players are omitted for clarity. A batter would be standing generally adjacent a set of batting stumps 14 at one end and they would be holding a bat 16. A ball 18 would be bowled from the other end of the pitch (adjacent the bowling end stumps 20), either by a bowler or by a bowling machine. An ultra-wide band (UWB) tag 22 is located within centre of the ball 18. This tag 22 sends radio signals, ideally within the range of 6-7 GHZ, to multiple anchors 24 placed around the playing area 10. In this embodiment there are six anchors placed with one generally at each corner and two in the middle of each long side. The system can use four anchors. More anchors may be used to increase accuracy. Other embodiments can have multiple adjacent netted playing areas with a suitable array of anchors disposed therearound. An accelerometer is provided in the tag 22 and data from this is also transmitted to be received externally.

A combination of Time of Arrival (ToA), Angle of Arrival (AoA), Time Difference of Arrival (TDoA), and Phase Difference of Arrival (PDoA) are used to accurately determine the location of the tag 22 within a 3D space relative to the anchors. Positional accuracy to less than 10 cm can be achieved. For setup of this embodiment, six anchors 24 are placed around the pitch in a rectangular pattern. The anchors share a source of truth timing for all TDoA calculations enabling the triangulation of points to help determine a location.

The anchors 24 and any integrated/associated controller together form a UWB sensor system (generally indicated 26 in FIG. 1) and this supplies a series of three-dimensional timestamped locations of the tag 22 (and thus the ball 20) to a processor 28. The processor may comprise a computer appropriately programmed to carry out the required calculations and commands. The processor uses software that overlays the raw positional data in a digital twin model of the playing area. This allows the specification of virtual zones within the playing area which in turn helps to manage known events and logic during ball flight. Two virtual zones are defined at the delivery end of the pitch to detect the direction and motion of the ball as it is delivered. Passage of the ball into, through, or out of these delivery trigger zones can initiate the system to start recording a delivery path as the ball is bowled. From this point on, ball locations are logged as part of delivery and shot paths until either a timeout is reached (for example after 3 seconds), or the ball reached the confines of the constrained playing area as the ball hits the net.

On completion of the delivery a Kalman filter is used to predict and train the model to higher levels of location accuracy according set parameters around the largest allowed covariance in each plane.

xₖ=Fₖxₖ₋₁+Bₖuₖ+wₖ

where Fₖ represents the transition model, Bₖ is the control input and uₖ is the control vector. Finally, wₖ represents the process noise of the system. This is then used for state zₖ of the true state xx according to the following:

zₖ=Hₖxₖ+vₖ

where Hₖ is the observation model and vₖ is the observation noise.

This method results in a higher accuracy of the noisy location data from the UWB sensor system based on known constraints represented by the covariance vectors in the process and observation vectors which are considered to be normal distributions.

Once filtered the data is then analysed to find the bounce point 30 of the delivery (if this occurred, as the ball may not bounce) and the strike point 32 at which the ball impacts the bat 16 (if indeed that occurred). The bounce point 30 is taken as the lowest point in the trajectory where there is an accelerometer change and is calculated using a machine learning algorithm.

To find the strike point 32 the system may initially look for a change in the acceleration. This would represent the ball being hit. To do this, all of the points of the delivery path are analysed to determine a delivery trajectory as this is a known value that will be recorded before the ball has been hit. Based on a minimum 100 Hz refresh rate of the tag and a ball travelling at 50 m/s. These locations are then used to form a predictive line of best fit of the delivery using linear regression in the x-z horizontal plane. The same approach is applied to the last 10 locations of the system deriving a line of best fit in the horizontal plane. These two sets are then compared to determine the x value of their intersect and so the x value of the potential strike point. If this point lies within a conceivable hitting zone e.g. 0<X<6 then it can be registered as relating to the strike point and the nearest ‘real world’ point on the trajectory to the predicted x location is set as the strike point. If no intersection point is found within the known hitting area it is determined that the ball was not hit, and no strike point is registered.

Locations prior to the strike point are determined to be part of the delivery path 36. These points are then used within a trajectory engine forming part of the processors to determine a smoothed delivery path for the simulation and equations of motion.

Locations registered after the strike point are determined to be part of a shot path 38. These points are used within the trajectory engine to determine the initial vector velocity of the ball after contact, which are sent into a physics engine within the processor.

In the trajectory engine, trajectories are calculated using the 3-Dimensional equations for ballistic motion in the presence of drag. The terminal velocity is represented by:

$${V}_{t} = \sqrt{\frac{2 \cdot m \cdot g}{{C}_{drag} \cdot ρ \cdot A}}$$

where m is mass of the ball, g=9.81 m/s, ρ=density of air, A=2D area of the ball and C_{drag}=Coefficient of drag for a cricket ball.

This can then be used with the following equations of motion to determine the path of the cricket ball under set conditions.

$$x ( t ) = \frac{{v}_{x 0} \cdot {v}_{t}}{g} \cdot ( 1 - {e}^{\frac{- g \cdot t}{{v}_{t}}} ) + {x}_{0}$$

$$y ( t ) = \frac{{v}_{t} \cdot ( {v}_{y 0} + {v}_{t} )}{g} \cdot ( 1 - {e}^{\frac{- g \cdot t}{{v}_{t}}} ) - {v}_{t} \cdot t + {Y}_{0}$$

$$z ( t ) = \frac{{v}_{z 0} \cdot {v}_{t}}{g} \cdot ( 1 - {e}^{\frac{- g \cdot t}{{v}_{t}}} ) + {x}_{0}$$

The model then uses predicted initial velocities for vₓ₀, v_{y0} and v_{z0} respectively calculated from the opening set of locations in the trajectory. An iterative algorithm is then used to determine the most accurate trajectory based on the known locations of the trajectory providing the best fit. A Root Mean Square Error (RMSE) regression technique is used to analyse each potential trajectory determining the initial velocities with the lowest RMSE and so the best fit for the data.

$$RSME = {\sum }_{0}^{n} \sqrt{\frac{{( {p}_{n} - {a}_{n} )}^{2}}{n}}$$

Once these initial velocities are determined, the calculated points of the delivery are used to map out the trajectory arc showing the motion of the cricket ball.

For mapping trajectories after the delivery bounce 30 there may be a limited dataset to accurately determine the predicted trajectory of the ball. When this occurs, i.e. less than 3 location points after bounce, a fallback method is used to determine the trajectory after the bounce based on the equations of motion prior to the bounce. In this case a set of assumptions are made. Firstly that the ball does not spin and that it will continue in the same direction as prior to the bounce. Secondly that the velocity will drop by 20% compared to that prior to the bounce in the horizontal plane. Finally, that the coefficient of restitution of the ball on standard surface is equal 0.58. This means that the initial vertical velocity can be represented by the following equation:

v_{yb}=0.58v_{ya}

Where v_{yb} is the velocity before the bounce calculated using the final velocity of the delivery trajectory before the bounce and v_{ya} is the initial vertical velocity of the ball after the bounce. This method can be used for any of the trajectories in the simulation providing the initial velocities, a subset of location points, the final velocity of the trajectory at a known location, and the equations of motion for the trajectory. For example the predicted trajectory of a shot beyond the net can be mapped to a field bounce point and then the method used to predict the bounce path. The parameters of the flight and bounce (especially a bounce in the field of play) can be adjusted based on user selectable criteria such as ground harness and atmospheric conditions.

Once the delivery and shot have been analysed the shot velocities are sent to the physics simulator to set the initial vector velocity of the ball in the simulator. This can be used to calculate the path of the ball in an un-interrupted trajectory, i.e. with no fielders present. The calculated shot path 38b is then used to determine if any fielders can intercept the ball before it hits the boundary. For each point the magnitude of distance between the fielder and the ball location and the directional vector in the horizontal plane is calculated using:

$${d}_{mag} = \sqrt{{( {x}_{f} - {x}_{b} )}^{2} + {( {z}_{f} - {z}_{b} )}^{2}}$$

$$\hat{x} = \frac{{x}_{f} - {x}_{b}}{{d}_{mag}}$$

$$\hat{z} = \frac{{z}_{f} - {z}_{b}}{{d}_{mag}}$$

The software then determines the fielder with the lowest intersection magnitude that still lies within the boundaries of the pitch and below 2.4 m in the vertical plane. This will be the fielder that will reach the ball first and field it. Finally the intersection point of a fielder path and the ball path is analysed to see if the ball has bounced or not when the fielder reaches it. All of this information will result in one of the following outcomes:
A boundary, 4 or 6 depending on if it has bounced.
A fielded ball that takes t seconds to return to the stumps.
A catch if the ball has reached the fielder before bouncing.

The number of runs for a fielded ball is then calculated by comparing the time in seconds that it took to field the ball, including the time to throw the ball back to the stumps, with the average time per run of the batter.

Although not shown in this embodiment, high speed timestamped cameras could be integrated into the system to record video of the session. These could be linked to the deliveries and shots and can be reviewed and replayed in an analytics engine.

All of the data from start to finish is stored for further analysis. On the completion of each delivery, metrics such as the speed of delivery, where the ball pitched (bounced), amount of swing (lateral movement of the ball in flight before strike), contact point, shot speed, launch angle of the shot, shot result and run area are all calculated. These can then be used to show coaches and players particular playing trends to allow them to develop and analyse their technique.

The shot and metrics can be displayed to users in near real time and after a shot. It can be displayed on a screen 60 connected to the processor. The users may interface with the system using a control interface 62. This could take various forms such a keyboard, touch screen or voice control.

FIG. 5 shows a ball according to the present invention. This can be used as part of the system/method described above, but is also an independent aspect of the invention. The ball 18 comprises a UWB tag 20 at its centre. To ensure an even weight distribution of the ball, the tag (which in this embodiment is approximately 28 mm×28 mm×8 mm) is embedded in a spherical silicone core 40. A silicone compound may be used due to its electronic insulation, low dielectric constant and physical properties, but other resins/materials are suitable. The resin core may be approximately 40 mm in diameter. The core may be surrounded by cork 42 and wrapped in string 44 to build up an outer core to the full diameter 68-70 mm suitable for a cricket ball. On the extremity of the core (either between the cork and string or outside the string), a wireless inductive charging loop 46 is located to allow for wireless charging of the tag when placed in a cradle (not shown). This is wired to a battery 50 within the tag 20 by a charging wire 52 passing through the outer core. The final layer of leather 48 is then applied and stitched following the normal process for cricket ball manufacturing.

In other embodiments the ball may have an alternative form of wireless charging component. This could be located nearer to or even within the core.

The ball may in embodiments forming part of the system or method may instead of a wireless charging component may instead have a point charging port in the ball and puncture a hole in the leather on the cross stitch to allow access.

The ball may also have other sensors carried thereon. For example, a gyroscope in the ball could be used to determine the rotation of the ball. These would provide additional data to help the calculations—for example to determine if the ball was hit or if the ball has just spun. These sensors would transmit live data to the processor by known means.

Other calculation algorithms can be used in the calculations such as Kalman filter change detection algorithm or Bayesian Change detection algorithm.

1. A cricket ball tracking and path prediction system, the system comprising: a cricket ball having a UWB tag contained therein; at least four UWB anchors that communicate with the UWB tag and are configured for placement around a constrained playing area; a processor arranged to receive calculated positional data from the UWB anchors and UWB tag, the processor being configured, using the calculated positional data, to:
determine when a delivery of the cricket ball has been initiated;
determine if and when the cricket ball has been struck by a batter;
define a delivery path and a shot path within the constrained playing area;
determine the vector velocities of the cricket ball upon strike; and
predict the shot path outside the constraints of the constrained playing area.

2. A cricket ball tracking and path prediction system as claimed in claim 1, wherein the UWB Tag also includes an accelerometer.

3. A cricket ball tracking and path prediction system as claimed in claim 1, wherein the playing area is constrained by a training net.

4. A cricket ball tracking and path prediction system as claimed in claim 1, wherein the UWB anchors are placed in known locations around the constrained playing area.

5. A cricket ball tracking and path prediction system as claimed in claim 1, wherein there are at least 6 UWB anchors around the constrained playing area.

6. A cricket ball tracking and path prediction system as claimed in claim 1, wherein the processor uses a digital representation of the playing area and that is separated into defined zones.

7. A cricket ball tracking and path prediction system as claimed in claim 1, further comprising a screen operatively connected to the processor to display tracking and other data to users during and/or after a bowling/shot episode.

8. A cricket ball tracking and path prediction system as claimed in claim 7, wherein the screen is configured to display the delivery and shot paths within a visual representation of the playing area.

9. A cricket ball tracking and path prediction system as claimed in claim 7 wherein the screen is configured to display the predicted shot path beyond the constrained playing area on a visual representation of a virtual cricket ground.

10. A cricket ball tracking and path prediction system as claimed in claim 1, wherein the processor includes a physics simulator to predict the shot path beyond the constraints of the constrained playing area.

11. A cricket ball tracking and path prediction system as claimed in claim 1, wherein the processor is configured to analyse the predicted shot path to determine game play scenarios.

12. A cricket ball tracking and path prediction method comprising; gathering positional data for the cricket ball using a UWB tag within the cricket ball and at least four UWB anchors placed around a constrained playing area, the UWB anchors being in communication with the UWB tag; determining when a delivery of the cricket ball has been initiated; determining if and when the cricket ball has been struck by a batter and the location of the ball upon strike; defining a delivery path and a shot path within the constrained playing area; determining the vector velocities of the cricket ball upon strike; and predicting the shot path beyond the constraints of the constrained playing area.

13. A cricket ball tracking and path prediction method as claimed in claim 12, wherein a visual representation of the constrained playing area and cricket ball path is displayed on a screen operatively connected to a processor.

14. A cricket ball tracking and path prediction method as claimed in claim 12, wherein a digital representation of the playing area is used in the ball tracking calculation process and that digital representation is separated into zones.

15. A cricket ball tracking and path prediction method as claimed in claim 12, wherein the positional data comprises three-dimensional timestamped locations.

16. A cricket ball comprising:
an inner core formed from a non-conductive material;
a wireless communication device contained within the inner core and at the centre of the ball and configured to transmit and receive a wireless signal;
an inductive charging component to which the communication tag is electrically connected; and
an outer shell surrounding the inner core and charging loop.

17. A cricket ball as claimed in claim 16, wherein the inner core is spherical.

18. A cricket ball as claimed in claim 16, wherein the non-conductive material is not permeable to liquid and/or has a low dielectric constant.

19. A cricket ball as claimed in claim 16, wherein the inner core is formed from a solid silicone compound within which the wireless communication device, and optionally the inductive charging component, is embedded.

20. A cricket ball as claimed in claim 16, wherein the wireless communication device is an ultra wideband (UWB) tag configured to transmit and receive a UWB signal.

21. A cricket ball as claimed in claim 20, wherein the wireless communication device further includes an accelerometer.

22. A cricket ball as claimed in claim 16, wherein the silicone compound or other non-conductive material has a shore hardness between A-60-100.

23. A cricket ball as claimed in claim 16, wherein an outer core surrounds the inner core.

24. A cricket ball as claimed in claim 23, wherein the inductive charging loop is external to the inner core.

25. A cricket ball as claimed in claim 16, wherein the inductive charging loop is located inwardly of the outer shell.
